(19) United States
(12) Patent Application Publication
(10) Pub. No.: US 2026/0258883 A1
(43) Pub. Date: Sep. 3, 2026

(54) VALVE TRIM APPARATUS TO REDUCE CAVITATION IN VALVES

(71) Applicant: EMERSON PROCESS MANAGEMENT (TIANJIN) VALVES CO., LTD., Tianjin (CN)

(72) Inventors: Hang Li, Tianjin (CN); Qian Liu, Tianjin (CN)

(21) Appl. No.: 19/553,921

(22) Filed: Mar. 2, 2026

(30) Foreign Application Priority Data
Mar. 3, 2025 (CN) 202510246921.4

(51) Int. Cl. F16K 47/06; F16K 1/40

(52) U.S. Cl. CPC F16K 47/06; F16K 1/40

(57) ABSTRACT

A valve trim apparatus to reduce cavitation in valves is disclosed. An example apparatus includes a valve cage defining a first chamber and a second chamber, and a plug positioned in and movable relative to the valve cage between an open position and a closed position, the plug including a first recess in an outer surface of the plug, a second recess in the outer surface, the second recess spaced apart from the first recess along a longitudinal axis of the plug, and a channel extending through the plug from the first recess to the second recess, the channel to fluidly couple the first chamber to the second chamber when the plug is in the open position, the plug to restrict fluid flow between the first chamber and the second chamber when the plug is in the closed position.

### RELATED APPLICATION

This patent claims the benefit of Chinese Patent Application No. 202510246921.4, which was filed on Mar. 3, 2025. Chinese Patent Application No. 202510246921.4 is hereby incorporated herein by reference in its entirety. Priority to Chinese Patent Application No. 202510246921.4 is hereby claimed.

### FIELD OF THE DISCLOSURE

This disclosure relates generally to valves and, more particularly, to a valve trim apparatus to reduce cavitation in valves.

### BACKGROUND

Valves are used to control flow of a fluid through a conduit. Valves commonly include a plug movable relative to a valve cage through which fluid can flow when the valve is opened. As the fluid exits a chamber of the valve to a fluid outlet, the fluid typically interacts with a relatively stationary or low-velocity fluid at the fluid outlet. Such interaction commonly results in cavitation.

### SUMMARY

An example valve assembly disclosed herein includes a valve body, a fluid inlet and a fluid outlet defined in the valve body, a fluid passageway defined in the valve body between the fluid inlet and the fluid outlet, a cage positioned in the fluid passageway, and a plug positioned in and movable relative to the cage between a closed position and an open position. The plug includes a first recess in an outer surface of the plug, a second recess in the outer surface, the second recess spaced apart from the first recess along a longitudinal axis of the plug, and a channel extending through the plug from the first recess to the second recess. The channel is to fluidly couple the fluid inlet to the fluid outlet when the plug is in the open position, and the plug is to restrict fluid flow through the channel when the plug is in the closed position.

An example apparatus disclosed herein includes a valve cage defining a first chamber and a second chamber, and a plug positioned in and movable relative to the valve cage between an open position and a closed position. The plug includes a first recess in an outer surface of the plug, a second recess in the outer surface, the second recess spaced apart from the first recess along a longitudinal axis of the plug, and a channel extending through the plug from the first recess to the second recess. The channel is to fluidly couple the first chamber to the second chamber when the plug is in the open position, and the plug is to restrict fluid flow between the first chamber and the second chamber when the plug is in the closed position.

An example valve plug disclosed herein includes an outer surface to engage an inner surface of a valve cage, a first recess in the outer surface, a second recess in the outer surface, the second recess spaced apart from the first recess along a longitudinal axis of the valve plug, and a channel extending through the valve plug from the first recess to the second recess. The channel is to fluidly couple a first chamber of the valve cage to a second chamber of the valve cage when the valve plug is in a first position in the valve cage, and the valve plug is to restrict fluid flow between the first chamber and the second chamber when the valve plug is in a second position in the valve cage.

### BRIEF DESCRIPTION OF THE DRAWINGS

FIG. 1 is a cross-sectional view of an example valve assembly in which examples disclosed herein may be implemented.

FIG. 2 is a cross-sectional view of a portion of the valve assembly of FIG. 1, with a plug in an open position.

FIG. 3 is an enlarged view of a portion of the valve assembly of FIGS. 1 and/or 2, with the plug in a closed position.

FIG. 4 is a perspective view of a first side of the plug of FIGS. 1, 2, and/or 3.

FIG. 5 is a perspective view of a second side of the plug of FIGS. 1, 2, 3, and/or 4.

FIG. 6 illustrates a portion of the plug of FIGS. 1, 2, 3, 4, and/or 5 proximate an end of the plug.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Valves are commonly implemented on a fluid conduit to control flow of fluid from a first location to a second location. When a valve is in a closed position, the valve can prevent and/or restrict fluid from a high-pressure region at an inlet of the valve from flowing to a low-pressure region at an outlet of the valve. Alternatively, when the valve is in an open position, the valve enables and/or allows the fluid to flow from the high-pressure region to the low-pressure region. Opening and closing of the valve can be performed manually or via a command signal from a process control system operatively coupled to the valve.

A trim assembly of a valve commonly includes a cage to reduce pressure of the fluid flowing through the valve. A plug is positioned in and/or movable relative to the cage to stroke the valve between the open and closed positions. In particular, the plug blocks (e.g., restricts, prevents) fluid flow through the cage in the closed position, and the plug allows (e.g., enables) fluid flow through the cage in the open position. In some cases, positioning the plug in a partially open position (e.g., between the closed position and the open position) can reduce a flow rate of the fluid compared to the flow rate of the fluid when the plug is in the fully open position.

In some cases, a sudden pressure drop though the valve can occur during and/or after movement of the plug from the closed position to the open position. In particular, fluid may be at a relatively high pressure upon entering the valve at a fluid inlet, and the fluid may be at a reduced pressure upon exiting the valve at a fluid outlet. In some instances, the fluid increases in velocity as the fluid travels through the valve and/or the cage. As the high-velocity fluid exits the valve, the high-velocity fluid interacts with relatively stationary or low-velocity fluid at the fluid outlet. Such interaction of fluids may result in noise. Further, the pressure drop through the valve during opening and/or throttling of the valve may result in cavitation. In such cases, bubbles in the fluid are formed and then subsequently collapse, which may result in increased wear and/or damage to one or more components of the valve.

Examples disclosed herein can reduce the occurrence of cavitation during operation of a valve by producing a gradual and/or stepped (e.g., staged) pressure drop across a plug and/or a cage of the valve. An example valve assembly disclosed herein includes a valve body defining a fluid inlet, a fluid outlet, and a fluid passageway extending between the fluid inlet and the fluid outlet. The valve assembly further includes an example trim assembly including an example cage positioned in the fluid passageway, and an example plug positioned in and movable relative to the cage between a closed position and an open position. In some examples, an outer surface of the plug and an inner surface of the cage define one or more chambers between the fluid inlet and the fluid outlet. The plug includes multiple example recesses (e.g., concave surfaces) in the outer surface, and further includes one or more example channels extending through the plug between respective pairs of the recesses.

In some examples, when the plug is in the closed position in the cage, the plug restricts (e.g., prevents, blocks) flow of fluid through the cage from the fluid inlet to the fluid outlet. Conversely, when the plug moves to the open position, the recesses overlap with respective ones of the chambers to enable fluid flow from the chambers to and/or through the channels. As a result, the fluid inlet is fluidly coupled to the fluid outlet via the channels and the chambers. In some examples, a pressure of the fluid drops (e.g., reduces) as the fluid travels into and/or out of successive ones of the channels from the fluid inlet to the fluid outlet (e.g., the pressure drops at areas proximate inlets and outlets of respective ones of the channels), resulting in a gradual and/or stepped pressure drop through the valve. Such a gradual and/or stepped pressure drop can reduce the occurrence of cavitation in the valve (e.g., compared to valves in which the pressure drop is sudden and/or rapid). Accordingly, disclosed examples can reduce wear of and/or damage to one or more components of the valve.

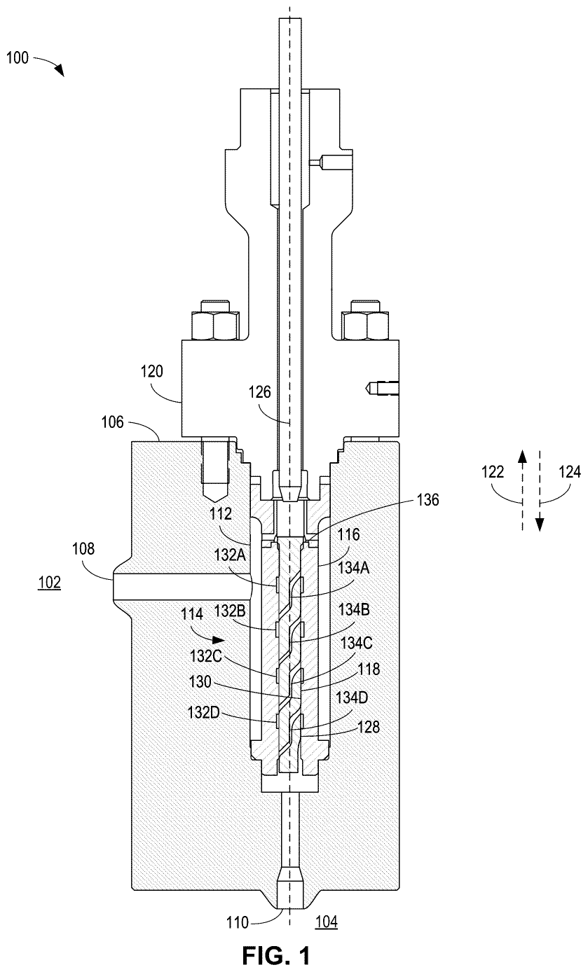

FIG. 1 is a cross-sectional view of an example valve assembly 100 in which examples disclosed herein may be implemented. In the illustrated example of FIG. 1, the valve assembly 100 can be used to control flow of fluid between a high-pressure region 102 and a low-pressure region 104. In some examples, a pressure drop (e.g., a pressure difference) between the high-pressure region 102 and the low-pressure region 104 is at least 6000 psi. In some examples, the pressure drop may be different (e.g., less than 6000 psi).

In the illustrated example of FIG. 1, the valve assembly 100 includes an example body (e.g., a valve body) 106 defining an example inlet (e.g., a fluid inlet) 108, an example outlet (e.g., a fluid outlet) 110, and an example fluid passageway 112 extending and/or fluidly coupled between the inlet 108 and the outlet 110. In some examples, the inlet 108 can receive fluid (e.g., high-pressure fluid) from the high-pressure region 102, and the fluid can flow to the outlet 110 and to the low-pressure region 104 via the fluid passageway 112.

In the illustrated example of FIG. 1, an example trim assembly (e.g., a valve trim assembly) 114 is positioned in the fluid passageway 112. The trim assembly 114 includes an example cage (e.g., a valve cage, a lower cage) 116 positioned in the fluid passageway 112, and an example plug (e.g., a valve plug) 118 positioned in and movable within the cage 116. In this example, an example bonnet (e.g., a valve bonnet) 120 is coupled to the body 106. In some examples, the plug 118 can move (e.g., translate) in a first direction 122 (e.g., a first longitudinal direction, upward in FIG. 1) and a second direction 124 (e.g., a second longitudinal direction, downward in FIG. 1) along an example longitudinal axis 126 of the plug 118.

In the illustrated example of FIG. 1, an outer surface 128 of the plug 118 engages (e.g., contacts) and/or slides relative to an inner surface 130 of the cage 116. Further, the inner surface 130 and the outer surface 128 define a first example chamber 132A, a second example chamber 132B, a third example chamber 132C, and a fourth example chamber 132D (collectively referred to herein as chambers 132) between the plug 118 and the cage 116. In some examples, the chambers 132 extend circumferentially around respective portions of the plug 118. In some examples, the chambers 132 have cross-sectional shapes that can be circular, elliptical, or any other suitable shape. In this example, four of the chambers 132 are defined between the inner and outer surfaces 130, 128. In some examples, a different number of the chambers 132 may be used instead (e.g., one, two, three, five or more).

In the illustrated example of FIG. 1, the plug 118 includes a first example channel 134A, a second example channel 134B, a third example channel 134C, and a fourth example channel 134D (collectively referred to herein as channels 134) extending through the plug 118 between respective locations along the outer surface 128 of the plug 118. In this example, the plug 118 is shown in a closed position in which the plug 118 contacts (e.g., engages) an example seat (e.g., a valve seat) 136 defined by the cage 116. In some examples, the seat 136 prevents the plug 118 from moving further downward (e.g., in the second direction 124) when the plug 118 contacts the seat 136. In this example, when the plug 118 is in the closed position, the plug 118 restricts (e.g., blocks, prevents) fluid from the inlet 108 from entering the cage 116 and, thus, from flowing to the outlet 110. Further, when the plug 118 is in the closed position, the plug 118 restricts (e.g., blocks, prevents) fluid from flowing to and/or from the chambers 132 and/or the channels 134. In some examples, the outer surface 128 of the plug 118 sealably engages portions of the inner surface 130 of the cage 116 to restrict the fluid flow between the chambers 132 and/or the channels 134.

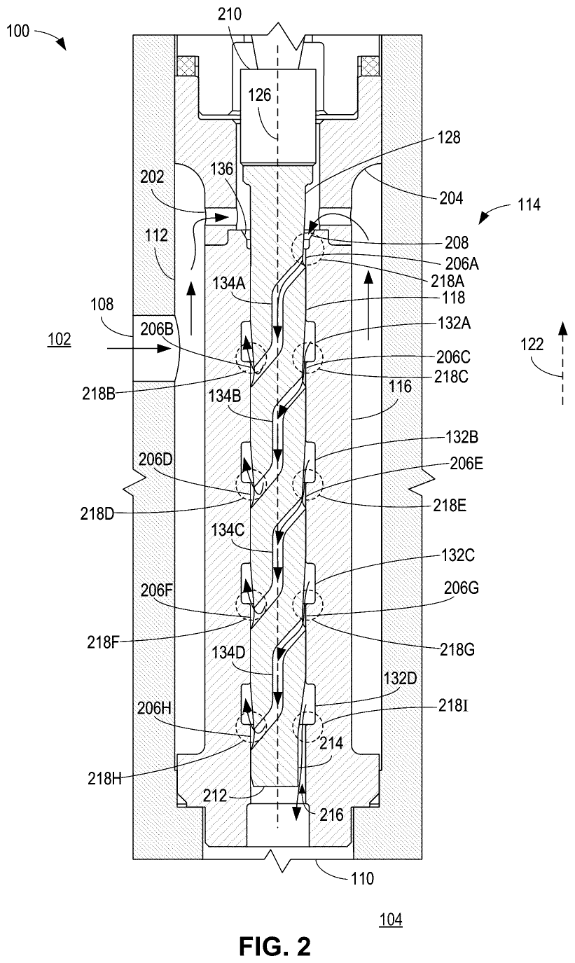

FIG. 2 is a cross-sectional view of a portion of the valve assembly 100 of FIG. 1, with the plug 118 in an open position. In some examples, the plug 118 moves from the closed position shown in FIG. 1 to the open position shown in FIG. 2 by travelling upward (e.g., in the first direction 122) from the closed position. In the illustrated example of FIG. 2, the outer surface 128 of the plug 118 is spaced apart from (e.g., does not contact) the seat 136 when the plug 118 is in the open position. In such examples, fluid from the high-pressure region 102 can enter the fluid passageway 112 via the inlet 108, and can flow into the cage 116 via one or more example ports (e.g., openings) 202 positioned between the cage 116 and an example upper cage 204 of the trim assembly 114.

In the illustrated example of FIG. 2, the plug 118 includes a first example recess (e.g., a concave surface, a micro-flat) 206A, a second example recess 206B, a third example recess 206C, a fourth example recess 206D, a fifth example recess 206E, a sixth example recess 206F, a seventh example recess 206G, and an eighth example recess 206H (collectively referred to herein as recesses 206) in the outer surface 128 of the plug 118. In some examples, the channels 134 extend through the plug 118 between respective pairs of the recesses 206. For example, the first channel 134A extends between the first and second recesses 206A, 206B, the second channel 134B extends between the third and fourth recesses 206C, 206D, the third channel 134C extends between the fifth and sixth recesses 206E, 206F, and the fourth channel 134D extends between the seventh and eighth recesses 206G, 206H. While the plug 118 includes eight of the recesses 206 in this example, a different number of the recesses 206 may be used instead. For example, the number of recesses 206 may be selected based on the number of the channels 134 in the plug 118.

When the plug 118 is in the open position of FIG. 2, the inlet 108 is fluidly coupled to the outlet 110 via the channels 134 and the chambers 132 in the plug 118. For example, when the plug 118 is in the open position, a portion of the recesses 206 overlap with respective ones of the chambers 132 and/or with an inlet region 208 defined in the cage 116. As a result, fluid can flow from the inlet region 208 to the chambers 132 via respective one(s) of the channels 134. Stated differently, the first channel 134A fluidly couples the inlet region 208 to the first chamber 132A, the second channel 134B fluidly couples the first chamber 132A to the second chamber 132B, the third channel 134C fluidly couples the second chamber 132B to the third chamber 132C, and the fourth channel 134D fluidly couples the third chamber 132C to the fourth chamber 132D.

While one of the channels 134 fluidly couples a respective pair of the chambers 132 in this example, the plug 118 can include multiple (e.g., additional) channels 134 to fluidly couple a respective pair of the chambers 132 in some examples. In some such examples, the multiple channels 134 extending between a respective pair of the chambers 132 are separate from one another (e.g., do not intersect in the plug 118). In some examples, at least a portion of the multiple channels 134 can intersect in the plug 118 (e.g., such that fluid from one of the multiple channels 134 can flow to different one(s) of the multiple channels 134 in the plug 118). In some examples, the number of the channels 134 extending between a respective pair of the chambers 132 can be selected based on pressure staging requirements for the plug 118 (e.g., based on a target pressure drop of the fluid between the respective pair of the chambers 132).

In the illustrated example of FIG. 2, the outer surface 128 of the plug 118 extends between a first end 210 and a second end 212 of the plug 118, where the first end 210 is proximate the bonnet 120 of FIG. 1 and the second end 212 is proximate the outlet 110. In this example, the plug 118 includes a tapered surface 214 proximate the second end 212, where the tapered surface 214 tapers inward (e.g., toward the longitudinal axis 126) from the outer surface 128. In some examples, when the plug 118 is in the open position of FIG. 2, the tapered surface 214 is spaced apart from (e.g., does not contact) the inner surface 130 of the cage 116, such that a gap 216 is defined between the tapered surface 214 and the inner surface 130. In such examples, fluid from the fourth chamber 132D can flow to the outlet 110 (e.g., the fourth chamber 132D is fluidly coupled to the outlet 110) via the gap 216. Thus, in the illustrated example of FIG. 2, the inlet 108 and, thus, the high-pressure region 102 are fluidly coupled to the outlet 110 and, thus, the low-pressure region 104 via the channels 134 and the chambers 132 when the plug 118 is in the open position.

An example flow path of fluid through the valve assembly 100 is indicated by the arrows shown in FIG. 2. In the illustrated example of FIG. 2, when the plug 118 is in the open position, fluid from the fluid passageway 112 enters the cage 116 via the ports 202 and the inlet region 208 of the cage 116. The fluid in the inlet region 208 enters the first recess 206A, then flows through the first channel 134A to the second recess 206B and, thus, to the first chamber 132A. Further, the fluid from the first chamber 132A enters the third recess 206C, then flows through the second channel 134B to the fourth recess 206D and, thus, to the second chamber 132B. In some examples, the fluid further flows through successive ones of the chambers 132 and the channels 134 (e.g., from the second chamber 132B to the third chamber 132C via the third channel 134C, and from the third chamber 132C to the fourth chamber 132D via the fourth channel 134D) and flows to the outlet 110 via the gap 216.

In some examples, a pressure of the fluid drops (e.g., is reduced) at multiple locations of the valve assembly 100 as the fluid flows from the inlet 108 to the outlet 110. In the illustrated example of FIG. 2, the pressure drops at a first example throttle area 218A, a second example throttle area 218B, a third example throttle area 218C, a fourth example throttle area 218D, a fifth example throttle area 218E, a sixth example throttle area 218F, a seventh example throttle area 218G, an eighth example throttle area 218H, and a ninth example throttle area 218I (collectively referred to herein as throttle areas 218). In some examples, the throttle areas 218 are proximate inlets and/or outlets of respective ones of the channels 134. In this example, a first pressure drop of the fluid occurs at the first throttle area 218A when the fluid passes from the inlet region 208 to the first channel 134A. In such examples, the fluid is at a first pressure in the inlet region 208, and the fluid is at a second pressure in the first channel 134, where the second pressure is less than the first pressure. Further, a second pressure drop of the fluid occurs at the second throttle area 218B when the fluid passes from the first channel 134A to the first chamber 132A. In such examples, the pressure of the fluid drops from the second pressure in the first channel 134A to a third pressure in the first chamber 132A, where the third pressure is less than the second pressure. In some examples, the pressure of the fluid further drops at successive ones of the throttle areas 218 (e.g., the fluid drops from the third pressure to a fourth pressure at the third throttle area 218C, the fluid drops from the fourth pressure to a fifth pressure at the fourth throttle area 218D, etc.). In some examples, a magnitude of the pressure drop decreases across subsequent ones of the throttle areas 218 (e.g., the second pressure drop at the second throttle area 218B is less than the first pressure drop at the first throttle area 218C, a third pressure drop at the third throttle area 218C is less than the second pressure drop at the second throttle area 218B, etc.).

In some examples, pressure recovery (e.g., pressure increase and/or pressure stabilization) of the fluid occurs at multiple locations of the valve assembly 100. For example, the pressure of the fluid recovers (e.g., increases, stabilizes, and/or remains substantially constant) between ones of the throttle areas 218 (e.g., in the channels 134 and/or the chambers 132). In some examples, pressure recovery occurs in the first channel 134A between the first and second throttle areas 218A, 218B, in the first chamber 132A between the second and third throttle areas 218B, 218C, in the second channel 134B between the third and fourth throttle areas 218C, 218D, in the second chamber 132B between the fourth and fifth throttle areas 218D, 218E, in the third channel 134C between the fifth and sixth throttle areas 218E, 218F, in the third chamber 132C between the sixth and seventh throttle areas 218F, 218G, in the fourth channel 134D between the seventh and eighth throttle areas 218G, 218H, in the fourth chamber 132D between the eighth and ninth throttle areas 218H, 218I, and/or in the gap 216 from the ninth throttle area 218I to the outlet 110. In some examples, because the channels 134, the chambers 132, and/or the gap 216 enable pressure recovery from and/or between the throttle areas 218, sudden and/or rapid pressure drops from the inlet 108 to the outlet 110 can be reduced.

In some examples, the throttle areas 218 and corresponding (e.g., subsequent) pressure recovery areas correspond to respective stages (e.g., pressure drop and recovery stages) of the valve assembly 100. For example, the first pressure drop at the first throttle area 218A and a corresponding pressure recovery at the first channel 134A corresponds to a first stage, the second pressure drop at the second throttle area 218B and a corresponding pressure recovery at the first chamber 132A corresponds to a second stage, etc. In this example, the valve assembly 100 includes nine stages. In some examples, the valve assembly 100 can include more or fewer stages (e.g., more or less than nine stages). In some examples, the number of the stages is selected based on a size of the valve body 106. In some examples, a total pressure drop of the fluid across the stages (e.g., from the inlet region 208 to the outlet 110) is at least 6000 psi. In some examples, the total pressure drop can be different (e.g., less than 6000 psi). For example, the total pressure drop can be adjusted by adjusting a number of the stages (e.g., by adjusting a number of the chambers 132 and/or the channels 134 in the plug 118), adjusting geometry of the chambers 132 and/or the channels 134, etc. In some examples, because the stages enable a gradual and/or staged pressure drop through the valve assembly 100 (e.g., from the inlet 108 to the outlet 110), the plug 118 can reduce and/or eliminate the occurrence of cavitation in one or more locations of the valve assembly 100.

In some examples, the plug 118 can be manufactured as a single part using, for example, additive manufacturing and/or any other suitable techniques. Similarly, the cage 116 can be manufactured as a single part using additive manufacturing and/or can be machined from a single piece of material (e.g., a metal block or bar). As a result, the valve assembly 100 can be manufactured more efficiently compared to some other multi-stage valves for which multiple separate components are manufactured and threaded and/or welded together to produce a plug and/or a cage. Further, because pressure recovery of the fluid can occur within the channels 134 of the valve assembly 100 (e.g., in addition to within the chambers 132), fewer chambers 132 may be required in the cage 116 of FIGS. 1 and/or 2 to achieve a desired total pressure drop and/or pressure recovery across the plug 118 (e.g., compared to some multi-stage valves in which pressure recovery occurs only in chambers of the cage). Because the valve assembly 100 of FIGS. 1 and/or 2 can achieve a desired pressure drop and/or pressure recovery using fewer of the chambers 132 (e.g., compared to some other multi-stage valves), a size (e.g., a length) of the cage 116 and, thus, of the valve assembly 100 can be reduced.

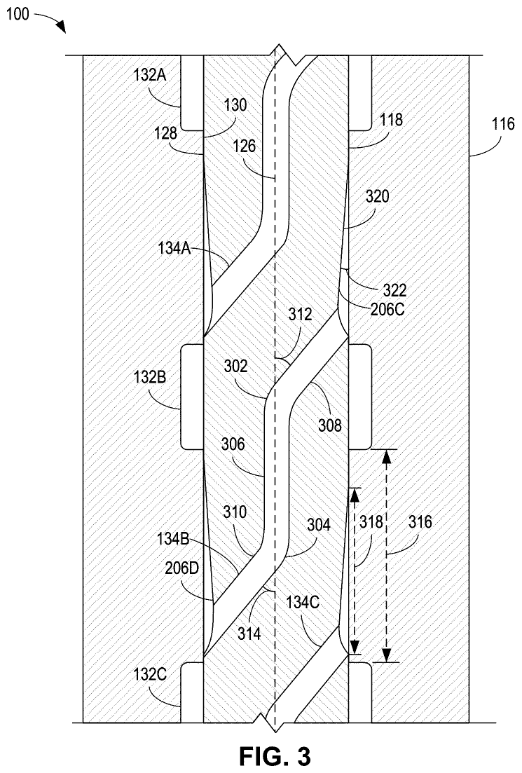

FIG. 3 is an enlarged view of a portion of the valve assembly 100 of FIGS. 1 and/or 2, with the plug 118 in the closed position. In the illustrated example of FIG. 3, the second channel 134B includes a first example bend 302 and a second example bend 304 in the plug 118 between the third recess 206C and the fourth recess 206D. In this example, a first portion 306 of the second channel 134B between the first bend 302 and the second bend 304 is substantially straight (e.g., not curved) and extends along (e.g., is oriented along, is substantially aligned with) the longitudinal axis 126 of the plug 118. Further, a second portion 308 of the second channel 134B between the first bend 302 and the third recess 206C is angled with respect to the longitudinal axis 126, and a third portion 310 of the second channel 134B between the second bend 304 and the fourth recess 206D is angled with respect to the longitudinal axis 126. In this example, a first example angle 312 between the second portion 308 and the longitudinal axis 126 is approximately equal to a second example angle 314 between the third portion 310 and the longitudinal axis 126. In some examples, the first angle 312 and the second angle 314 are 45 degrees or less. In some examples, the first angle 312 and/or the second angle 314 may be different (e.g., greater than 45 degrees).

In some examples, a geometry of the second channel 134B may be different (e.g., may include fewer or additional bends, may be substantially straight and/or uncurved between the third and fourth recesses 206C, 206D, etc.). In some examples, the channels 134 have substantially the same geometry and/or dimensions (e.g., a description of the geometry of the second channel 134B can equally apply to any of the first channel 134A, the third channel 134C, and/or the fourth channel 134D). In some examples, at least one of the channels 134 can have a different geometry and/or different dimensions relative to other one(s) of the channels 134.

In the illustrated example of FIG. 3, the chambers 132 are spaced apart from one another along the longitudinal axis 126 by a first example length 316, and the recesses 206 extend along the longitudinal axis 126 by a second example length 318, where the second length 318 is less than the first length 316. In some examples, a spacing (e.g., the first length 316) between the chambers 132 may vary (e.g., a distance between a first pair of the chambers 132 can be different from the distance between a second pair of the chambers 132).

In this example, the recesses 206 include respective first example surfaces 320 which are angled with respect to the outer surface 128 of the plug 118 and/or the inner surface 130 of the cage 116. In this example, a third example angle 322 between the first surfaces 320 and the outer surface 128 is 10 degrees or less. In some examples, the third angle 322 may be different (e.g., greater than 10 degrees). As a result of the first surfaces 320 being angled with respect to the outer and inner surfaces 128, 130, a gap (e.g., a spacing) between the first surfaces 320 and the inner surface 130 of the cage 116 can increase (e.g., gradually and/or linearly increase) when the plug 118 moves from the closed position of FIGS. 1 and/or 3 to the open position of FIG. 2. In such examples, a flow rate of fluid into the channels 134 gradually increases as the plug 118 moves from the closed position to the open position, thereby reducing occurrence of cavitation resulting from sudden and/or rapid pressure drops through the plug 118.

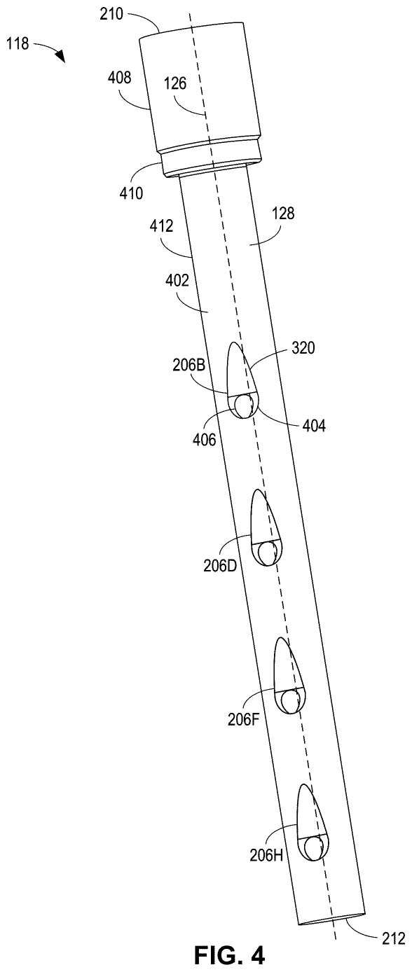

FIG. 4 is a perspective view of a first side 402 of the plug 118 of FIGS. 1, 2, and/or 3. In the illustrated example of FIG. 4, the second, fourth, sixth, and eighth recesses 206B, 206D, 206F, 206H are positioned on the first side 402 of the plug 118 and are substantially aligned in a longitudinal direction (e.g., along the longitudinal axis 126) of the plug 118. In some examples, at least one of the recesses 206B, 206D, 206F, 206H is not substantially aligned with other one(s) of the recesses 206B, 206D, 206F, 206H in the longitudinal direction (e.g., the at least one of the recesses 206B, 206D, 206F, 206H is rotated about the longitudinal axis 126 with respect to the other one(s) of the recesses 206B, 206D, 206F, 206H). In this example, the recesses 206B, 206D, 206F, 206H include the respective first surfaces 320 and respective example second surfaces 404 angled with respect to the outer surface 128 of the plug 118. Further, example openings 406 are positioned and/or defined in respective ones of the second surfaces 404, where the openings 406 are fluidly coupled to respective ones of the channels 134 of FIGS. 1, 2, and 3.

In the illustrated example of FIG. 4, the plug 118 includes a first cylindrical portion 408, a second cylindrical portion 410, and a third cylindrical portion 412. In this example, the first cylindrical portion 408 is proximate the first end 210 of the plug 118, the third cylindrical portion 412 is proximate the second end 212 of the plug 118, and the second cylindrical portion 410 is between the first cylindrical portion 408 and the third cylindrical portion 412. In this example, the first cylindrical portion 408 has a first diameter, the second cylindrical portion 410 has a second diameter, and the third cylindrical portion 412 has a third diameter, where the second diameter is less than the first diameter and the third diameter is less than the second diameter. In some examples, the second cylindrical portion 410 engages (e.g., contacts, sealably engages) the seat 136 of the cage 116 of FIG. 1 when the plug 118 is in the closed position.

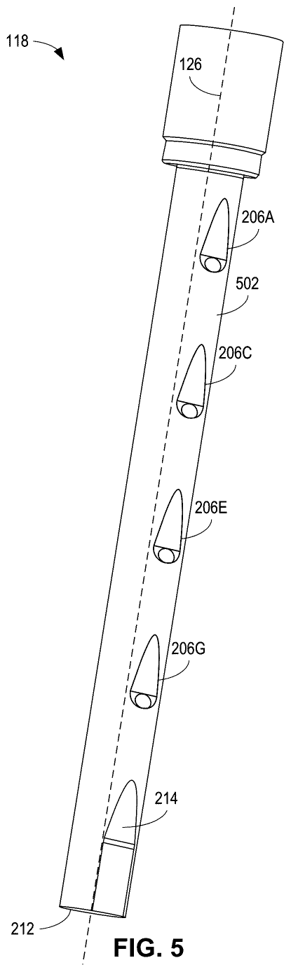

FIG. 5 is a perspective view of a second side 502 of the plug 118 of FIGS. 1, 2, 3, and/or 4, where the second side 502 is opposite the first side 402 of FIG. 4. In the illustrated example of FIG. 5, the first, third, fifth, and seventh recesses 206A, 206C, 206E, 206G are positioned on the second side 502 and are substantially aligned in a longitudinal direction (e.g., parallel to the longitudinal axis 126) of the plug 118. In some examples, at least one of the recesses 206A, 206C, 206E, 206G is not substantially aligned with other one(s) of the recesses 206A, 206C, 206E, 206G in the longitudinal direction (e.g., the at least one of the recesses 206A, 206C, 206E, 206G is rotated about the longitudinal axis 126 with respect to the other one(s) of the recesses 206A, 206C, 206E, 206G).

In some examples, the third, fifth, and seventh recesses 206C, 206E, 206G are positioned along a same circumference of the plug 118 as respective ones of the second, fourth, and sixth recesses 206B, 206D, 206F of FIG. 4. For example, the second recess 206B and the third recess 206C are positioned along a first circumference of the plug 118, the fourth recess 206D and the fifth recess 206E are positioned along a second circumference of the plug 118, and the sixth recess 206F and the seventh recess 206G are positioned along a third circumference of the plug 118. In some examples, the second recess 206B and the third recess 206C, the fourth recess 206D and the fifth recess 206E, and the sixth recess 206F and the seventh recess 206G are on opposite sides of the plug 118 (e.g., are diametrically opposed on the plug 118). For example, ones of the recesses 206 corresponding to a circumferential pair (e.g., the second recess 206B and the third recess 206C, the fourth recess 206D and the fifth recess 206E, and/or the sixth recess 206F and the seventh recess 206G) are rotated and/or offset from one another by 180 degrees about the longitudinal axis 126. In some examples, the ones of the recesses 206 can be offset from one another by less than 180 degrees about the longitudinal axis 126.

In the illustrated example of FIG. 5, the tapered surface 214 is positioned proximate the second end 212 of the plug 118 and is substantially aligned with the first, third, fifth, and seventh recesses 206A, 206C, 206E, 206G in the longitudinal direction (e.g., along the longitudinal axis 126). In some examples, a position of the tapered surface 214 may be different. For example, the tapered surface 214 may not be substantially aligned with the recesses 206A, 206C, 206E, 206G (e.g., the tapered surface 214 may be rotated about the longitudinal axis 126 with respect to the recesses 206A, 206C, 206E, 206G) in some examples. Further, while the plug 118 includes the one tapered surface 214 in this example, the plug 118 can include multiple ones of the tapered surface 214 in some examples.

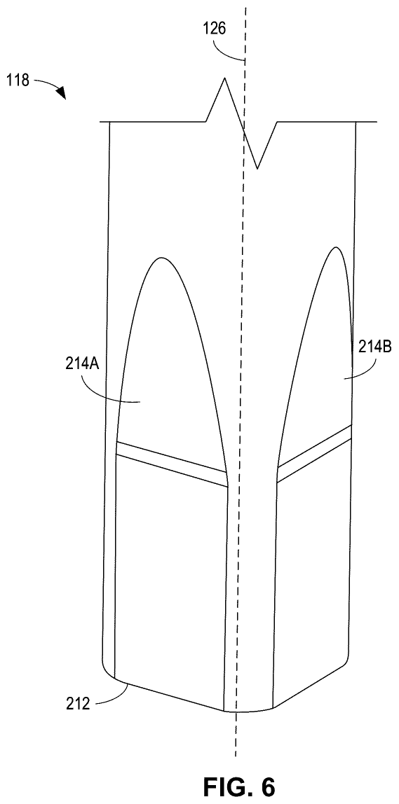

For example, FIG. 6 illustrates a portion of the plug 118 of FIGS. 1, 2, 3, 4, and/or 5 proximate the second end 212 of the plug 118. In the illustrated example of FIG. 6, the plug 118 includes a first tapered surface 214A and a second tapered surface 214B proximate the second end 212. In this example, the second tapered surface 214B is offset from (e.g., rotated about the longitudinal axis 126 from) the first tapered surface 214A by approximately 90 degrees. In some examples, the offset between the first and second tapered surfaces 214A, 214B can be different in some examples (e.g., greater than or less than 90 degrees). While the plug 118 includes two of the tapered surfaces 214A, 214B in this example, the plug 118 can include a different number of the tapered surfaces 214A, 214B (e.g., one, three or more) in some examples. In some examples, the number of the tapered surfaces 214A, 214B is selected based on a desired pressure drop of fluid from the fourth chamber 132D to the outlet 110 of FIG. 1.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately,” “substantially,” and “about” modify their subjects/values to recognize the potential presence of variations that occur in real world applications. For example, “approximately,” “substantially,” and “about” may modify dimensions that may not be exact due to manufacturing tolerances and/or other real world imperfections as will be understood by persons of ordinary skill in the art. For example, “approximately,” “substantially,” and “about” may indicate such dimensions may be within a tolerance range of +/−10% unless otherwise specified herein.

From the foregoing, it will be appreciated that example systems, apparatus, articles of manufacture, and methods have been disclosed that reduce cavitation in valves. An example valve assembly disclosed herein includes an example cage positioned in a fluid passageway between a fluid inlet and a fluid outlet of the valve assembly, where the cage defines one or more example chambers. An example plug is positioned in and/or movable within the cage. The plug includes example recesses in an outer surface of the cage, and one or more example channels extending through the plug and fluidly coupled to and/or between ones of the recesses. In some examples, when the plug is in an open position in the cage, fluid from the fluid inlet can flow to the fluid outlet via successive ones of the chambers and the channels, where a pressure of the fluid can be reduced gradually and/or in stages across the chambers and the channels. By enabling a gradual reduction of the pressure of the fluid from the fluid inlet to the fluid outlet, examples disclosed herein can reduce the occurrence of cavitation resulting from sudden and/or rapid changes in pressure, thus reducing likelihood of damage to one or more components of the valve assembly. Additionally, because pressure recovery of the fluid can occur within the channels in addition to the chambers, disclosed examples may require fewer chambers to be included in the cage in order to achieve a desired pressure recovery across the plug (e.g., compared to some valves in which pressure recovery occurs only in chambers of the cage). As a result, disclosed examples can reduce a size of the cage and, thus, of the valve assembly, thereby reducing material and/or part costs associated with manufacture of the valve assembly. Disclosed systems, apparatus, articles of manufacture, and methods are accordingly directed to one or more improvement(s) in the operation of a machine such as a computer or other electronic and/or mechanical device.

An example valve trim assembly to reduce cavitation in valves is disclosed herein. Further examples and combinations thereof include the following:
Example 1 includes a valve assembly comprising a valve body, a fluid inlet and a fluid outlet defined in the valve body, a fluid passageway defined in the valve body between the fluid inlet and the fluid outlet, a cage positioned in the fluid passageway, and a plug positioned in and movable relative to the cage between a closed position and an open position, the plug including a first recess in an outer surface of the plug, a second recess in the outer surface, the second recess spaced apart from the first recess along a longitudinal axis of the plug, and a channel extending through the plug from the first recess to the second recess, the channel to fluidly couple the fluid inlet to the fluid outlet when the plug is in the open position, the plug to restrict fluid flow through the channel when the plug is in the closed position.
Example 2 includes the valve assembly of example 1, wherein the first recess includes a first surface and a second surface, the first surface angled relative to the outer surface of the plug, the second surface including an opening fluidly coupled to the channel.
Example 3 includes the valve assembly of any one or more of examples 1-2, wherein a gap between the first surface and an inner surface of the cage increases when the plug moves from the closed position to the open position.
Example 4 includes the valve assembly of any one or more of examples 1-3, wherein the channel includes a first bend and a second bend, a portion of the channel between the first bend and the second bend extending along the longitudinal axis.
Example 5 includes the valve assembly of any one or more of examples 1-4, wherein the cage defines a first chamber and a second chamber, the channel to fluidly couple the first chamber to the second chamber when the plug is in the open position, the plug to restrict the fluid flow between the first chamber and the second chamber when the plug is in the closed position.
Example 6 includes the valve assembly of any one or more of examples 1-5, wherein the first recess and the second recess are on opposite sides of the outer surface.
Example 7 includes the valve assembly of any one or more of examples 1-6, wherein the channel is a first channel, and the plug further includes a third recess and a fourth recess in the outer surface, the third recess and the second recess positioned along a same circumference of the plug, the fourth recess spaced apart from the second recess and the third recess along the longitudinal axis, and a second channel extending through the plug from the third recess to the fourth recess, the plug to enable fluid flow from the first channel to the second channel when the plug is in the open position, the plug to restrict the fluid flow from the first channel to the second channel when the plug is in the closed position.
Example 8 includes the valve assembly of any one or more of examples 1-7, wherein the outer surface extends between a first end and a second end of the plug, the second end proximate the fluid outlet, the plug including a tapered surface proximate the second end.
Example 9 includes an apparatus comprising a valve cage defining a first chamber and a second chamber, and a plug positioned in and movable relative to the valve cage between an open position and a closed position, the plug including a first recess in an outer surface of the plug, a second recess in the outer surface, the second recess spaced apart from the first recess along a longitudinal axis of the plug, and a channel extending through the plug from the first recess to the second recess, the channel to fluidly couple the first chamber to the second chamber when the plug is in the open position, the plug to restrict fluid flow between the first chamber and the second chamber when the plug is in the closed position.
Example 10 includes the apparatus of example 9, wherein the first recess includes a first surface and a second surface, the first surface angled relative to the outer surface of the plug, the second surface including an opening fluidly coupled to the channel.
Example 11 includes the apparatus of example 10, wherein a gap between the first surface and an inner surface of the valve cage increases when the plug moves from the closed position to the open position.
Example 12 includes the apparatus of any one or more of examples 9-11, wherein the channel includes a first bend and a second bend, a portion of the channel between the first bend and the second bend extending along the longitudinal axis.
Example 13 includes the apparatus of any one or more of examples 9-12, wherein the first recess and the second recess are on opposite sides of the outer surface.
Example 14 includes the apparatus of any one or more of examples 9-13, wherein the channel is a first channel, and the plug further includes a third recess and a fourth recess in the outer surface, the third recess and the second recess positioned along a same circumference of the plug, the fourth recess spaced apart from the second recess and the third recess along the longitudinal axis, and a second channel extending through the plug from the third recess to the fourth recess, the plug to enable fluid flow from the second chamber to the second channel when the plug is in the open position, the plug to restrict the fluid flow from the second chamber to the second channel when the plug is in the closed position.
Example 15 includes the apparatus of any one or more of examples 9-14, wherein the outer surface extends between a first end and a second end of the plug, the plug including a tapered surface proximate the second end.
Example 16 includes a valve plug comprising an outer surface to engage an inner surface of a valve cage, a first recess in the outer surface, a second recess in the outer surface, the second recess spaced apart from the first recess along a longitudinal axis of the valve plug, and a channel extending through the valve plug from the first recess to the second recess, the channel to fluidly couple a first chamber of the valve cage to a second chamber of the valve cage when the valve plug is in a first position in the valve cage, the valve plug to restrict fluid flow between the first chamber and the second chamber when the valve plug is in a second position in the valve cage.
Example 17 includes the valve plug of example 16, wherein the first recess includes a first surface and a second surface, the first surface angled relative to the outer surface, the second surface including an opening fluidly coupled to the channel.
Example 18 includes the valve plug of any one or more of examples 16-17, wherein the channel includes a first bend and a second bend, a portion of the channel between the first bend and the second bend extending along the longitudinal axis.
Example 19 includes the valve plug of any one or more of examples 16-18, wherein the channel is a first channel, and further including a third recess and a fourth recess in the outer surface, the third recess and the second recess positioned along a same circumference of the valve plug, the fourth recess spaced apart from the second recess and the third recess along the longitudinal axis, and a second channel extending through the valve plug from the third recess to the fourth recess.
Example 20 includes the valve plug of any one or more of examples 16-19, further including a tapered surface proximate an end of the valve plug.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A valve assembly comprising:
a valve body;
a fluid inlet and a fluid outlet defined in the valve body;
a fluid passageway defined in the valve body between the fluid inlet and the fluid outlet;
a cage positioned in the fluid passageway; and
a plug positioned in and movable relative to the cage between a closed position and an open position, the plug including:
a first recess in an outer surface of the plug;
a second recess in the outer surface, the second recess spaced apart from the first recess along a longitudinal axis of the plug; and
a channel extending through the plug from the first recess to the second recess, the channel to fluidly couple the fluid inlet to the fluid outlet when the plug is in the open position, the plug to restrict fluid flow through the channel when the plug is in the closed position.

2. The valve assembly of claim 1, wherein the first recess includes a first surface and a second surface, the first surface angled relative to the outer surface of the plug, the second surface including an opening fluidly coupled to the channel.

3. The valve assembly of claim 2, wherein a gap between the first surface and an inner surface of the cage increases when the plug moves from the closed position to the open position.

4. The valve assembly of claim 1, wherein the channel includes a first bend and a second bend, a portion of the channel between the first bend and the second bend extending along the longitudinal axis.

5. The valve assembly of claim 1, wherein the cage defines a first chamber and a second chamber, the channel to fluidly couple the first chamber to the second chamber when the plug is in the open position, the plug to restrict the fluid flow between the first chamber and the second chamber when the plug is in the closed position.

6. The valve assembly of claim 1, wherein the first recess and the second recess are on opposite sides of the outer surface.

7. The valve assembly of claim 1, wherein the channel is a first channel, and the plug further includes:
a third recess and a fourth recess in the outer surface, the third recess and the second recess positioned along a same circumference of the plug, the fourth recess spaced apart from the second recess and the third recess along the longitudinal axis; and
a second channel extending through the plug from the third recess to the fourth recess, the plug to enable fluid flow from the first channel to the second channel when the plug is in the open position, the plug to restrict the fluid flow from the first channel to the second channel when the plug is in the closed position.

8. The valve assembly of claim 1, wherein the outer surface extends between a first end and a second end of the plug, the second end proximate the fluid outlet, the plug including a tapered surface proximate the second end.

9. An apparatus comprising:
a valve cage defining a first chamber and a second chamber; and
a plug positioned in and movable relative to the valve cage between an open position and a closed position, the plug including:
a first recess in an outer surface of the plug;
a second recess in the outer surface, the second recess spaced apart from the first recess along a longitudinal axis of the plug; and
a channel extending through the plug from the first recess to the second recess, the channel to fluidly couple the first chamber to the second chamber when the plug is in the open position, the plug to restrict fluid flow between the first chamber and the second chamber when the plug is in the closed position.

10. The apparatus of claim 9, wherein the first recess includes a first surface and a second surface, the first surface angled relative to the outer surface of the plug, the second surface including an opening fluidly coupled to the channel.

11. The apparatus of claim 10, wherein a gap between the first surface and an inner surface of the valve cage increases when the plug moves from the closed position to the open position.

12. The apparatus of claim 9, wherein the channel includes a first bend and a second bend, a portion of the channel between the first bend and the second bend extending along the longitudinal axis.

13. The apparatus of claim 9, wherein the first recess and the second recess are on opposite sides of the outer surface.

14. The apparatus of claim 9, wherein the channel is a first channel, and the plug further includes:
a third recess and a fourth recess in the outer surface, the third recess and the second recess positioned along a same circumference of the plug, the fourth recess spaced apart from the second recess and the third recess along the longitudinal axis; and
a second channel extending through the plug from the third recess to the fourth recess, the plug to enable fluid flow from the second chamber to the second channel when the plug is in the open position, the plug to restrict the fluid flow from the second chamber to the second channel when the plug is in the closed position.

15. The apparatus of claim 9, wherein the outer surface extends between a first end and a second end of the plug, the plug including a tapered surface proximate the second end.

16. A valve plug comprising:
an outer surface to engage an inner surface of a valve cage;
a first recess in the outer surface;
a second recess in the outer surface, the second recess spaced apart from the first recess along a longitudinal axis of the valve plug; and
a channel extending through the valve plug from the first recess to the second recess, the channel to fluidly couple a first chamber of the valve cage to a second chamber of the valve cage when the valve plug is in a first position in the valve cage, the valve plug to restrict fluid flow between the first chamber and the second chamber when the valve plug is in a second position in the valve cage.

17. The valve plug of claim 16, wherein the first recess includes a first surface and a second surface, the first surface angled relative to the outer surface, the second surface including an opening fluidly coupled to the channel.

18. The valve plug of claim 16, wherein the channel includes a first bend and a second bend, a portion of the channel between the first bend and the second bend extending along the longitudinal axis.

19. The valve plug of claim 16, wherein the channel is a first channel, and further including:
a third recess and a fourth recess in the outer surface, the third recess and the second recess positioned along a same circumference of the valve plug, the fourth recess spaced apart from the second recess and the third recess along the longitudinal axis; and
a second channel extending through the valve plug from the third recess to the fourth recess.

20. The valve plug of claim 16, further including a tapered surface proximate an end of the valve plug.
